(19) United States
(12) Patent Application Publication
(10) Pub. No.: US 2004/0053656 A1
(43) Pub. Date: Mar. 18, 2004

(54) Hi - lo poker game method and device

(76) Inventor: Tom Franklin, Gulfport, MS (US)

Correspondence Address: Anderson & Morishita, L.L.C., Suite 102, 2725 S. Jones Blvd., Las Vegas, NV, 89146, US

(21) Appl. No.: 10/610,229

(22) Filed: Jun. 30, 2003

Related U.S. Application Data
(60) Provisional application No. 60/393,294, filed on Jul. 1, 2002.

(51) Int. Cl. A63F 13/00

(52) U.S. Cl. 463/12

(57) ABSTRACT

A poker game method and device are set forth where each of a player and a dealer are dealt three cards which are assembled into a one card low hand and a two card high hand, according to a predetermined ranking schedule based on Poker rankings. The player and dealer hands are compared and if both the player's hands outrank the dealers hands, the player wins their wager. If both the dealer's hands outrank the player's, the player's wager is lost and if one of the player's hands outranks the dealer's but the other does not, the hand is considered to be a tie and the player's wager is neither won or lost.

### CROSS-REFERENCE TO RELATED APPLICATION

This application is a conversion application of a commonly owned, prior filed provisional patent application serial No. 60/393,294 filed Jul. 1, 2003 and titled “HI-LO POKER GAME METHOD AND DEVICE”

### FIELD OF THE INVENTION

The present invention relates to methods for playing Poker-type card games.

### BACKGROUND

Poker games using playing cards are popular and well known. In most of the live table games, the play includes using five or more playing cards to from a hand. In player-banked games, rounds of player wagering are provided to form a pot for the hand. The player(s) with the highest Poker ranked hands win the pot, less any commission for the house.

There are also house-banked Poker-type games such as the poker game described in Suttle et al, U.S. Pat. No. 4,836,553 titled POKER GAME the disclosure of which is incorporated by reference. This game also provides for a jackpot side wager and payment of jackpots for certain player Poker ranked holdings.

Another game is known as Pai Gow Poker played in many casinos and card clubs. To play the game the players each make a wager to play a hand. Seven cards are dealt to each player and the dealer. From the seven cards, each player makes a two card low hand and a five card high hand. The high hand must have a Poker ranking higher than that of the low hand. In my patent JACKPOT PAI GOW POKER, U.S. Pat. No. 5,584,486 issued Dec. 17, 1996, the disclosure of which is hereby incorporated by reference, the game of Pai Gow Poker is described.

It has also been known to convert traditionally live Poker games into electronic games. For example, it has been known to provide an electronic version of the poker game of Suttle et al identified above.

### SUMMARY OF THE INVENTION

Accordingly there is set forth according to the present invention a game method and device which provides a new Poker game.

There is set forth a method for playing a Poker game using a 52 card deck of playing cards. The method includes the player making a wager to participate in the game. A hand ranking schedule is set forth for play, the ranking being the traditional Poker rankings excluding straights, flushes, four-of-a-kinds and three-of-a-kinds. Three cards are dealt to a player and three cards to a dealer face down. Each of the player and dealer cards are assembled into making a one card low hand and a two card high hand, said high hand having a higher schedule ranking than the low hand. The rankings of the corresponding player and dealer low and high hands are compared and (a) if both of the piayer's hands outrank the dealer's hands awarding the player based upon the wager, (b) if both of the dealer's hands outrank the player's hands, collecting the player's wager and (c) if the one of the dealer's hands outranks the corresponding player hand and the other of the dealer's hands is outranked by the corresponding player hand, the player neither wins or loses the wager.

Thus the hands are easy and simple to assemble and compare. Further the game moves quickly since only three cards per hand are involved.

The device of the present invention includes a computer processor and an electronic display controlled by the processor. At least one data structure is provided for storing data corresponding to each card of at least a fifty-two card deck of playing cards and a ranking schedule, said schedule being the traditional Poker ranking hierarchy of poker hands excluding straights, flushes, four-of-a-kind and three-of-a-kind. The device has an apparatus for a player to make a wager and prompt play such as a toke acceptor, credit device or the like. The processor is configured to, upon prompting of play, randomly select and display at the display three player cards face up and three dealer cards face down. Input apparatus is configured for the player to arrange the player cards into a one card low hand and a two card high hand, the high hand having a higher schedule ranking than the low hand. The processor is configured to (a) arrange and display face up the dealer cards into a one card low hand and a two card high hand, the high hand having a higher ranking than the low hand, (b) to compare the corresponding player and dealer low and high hands and (c) if both of the player's hands outrank the dealer's issue an award to the player based upon the wager, (d) if both of the dealer's hands outrank the player's, collect the player's wager and (e) if the one of the dealer's hands outranks the corresponding player hand and the other of the dealer's hands is outranked by the corresponding player hand, neither collect the wager or issue an award.

### BRIEF DESCRIPTION OF THE DRAWINGS

FIG. 1 shows a lay out for live play of the game according to the method of the present invention; and

FIG. 2 shows a device fo electronic play of the game according to the present invention.

### DESCRIPTION

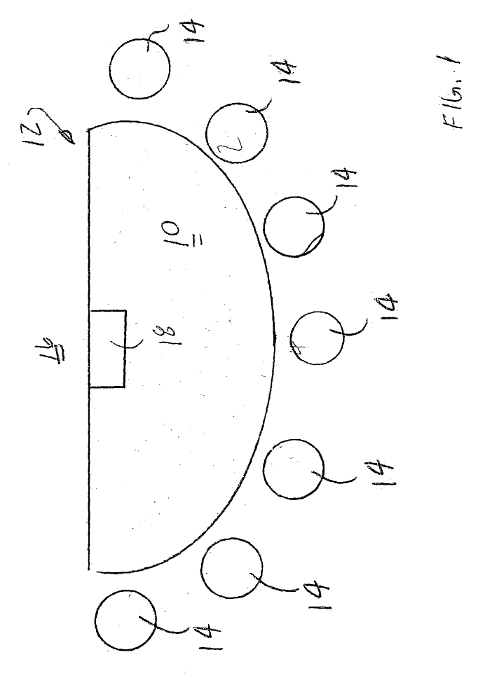

Turning to the drawings, at FIG. 1 there is shown a layout 10 for a gaming table 12 for the play of the game method of the present invention in a live game format. Disposed about the layout 10 are a number of player positions 14 to be occupied by players. Opposite the player positions 14 is a dealer position 16.

Proximate the dealer position 16 is a chip tray 18 to hold chips exchanged between the dealer and player during the play of the game.

To play the game, at least one standard deck of fifty-two cards is used. Each player participating in the game makes a wager by placing the same, as is known in the art, on the layout at their respective player position 14. After all participating players have made their wager, the dealer deals three cards (face up or face down) to each participating player and three cards (face down) to himself. The dealer's three cards are placed on the layout 10 in front of the tray 18. Each player then arranges their three cards into a one card low hand and a two card high hand. In assessing the rankings of hands according to the method of the present invention, the standard Poker rankings are used except that straights or flushes are not considered. Further, since only two cards are included in any hand (the high hand) threes-of-a-kind, fours-of-a-kind, two pairs, Straight Flushes and Royal Flushes are also not included in the ranking schedule. Thus the hierarchy of rankings according to the present invention are as shown in Table 1 below.

TABLE 1

| Low Hand | High Hand |
|---|---|
| Card Value, | Pair |
| Ace high | Card Values, Ace high |

The player must set the low and high hands such that the high hand has a higher ranking, otherwise the player has mis-set the hand and it is a loser.

After each player has arranged their two hands, the dealer exposes their cards and arranges his cards into a corresponding one card low hand and a two card high hand. The dealer may be required to set his hands according to a predetermined strategy.

After the players' and dealer's hands have been set the dealer compares, with each player, his low and high hands to the corresponding player low and high hands. If both of the player's hands outrank the dealers corresponding hands, the player wins and is paid based upon their wager. If desired, a commission may be assessed for winning hands. If both of the dealer's hands outrank the player's corresponding hands, the dealer is declared the winner and the player's wager is lost and is collected by the dealer. If the one of the dealer's hands outranks the corresponding player hand and the other of the dealer's hands is outranked by the corresponding player hand, the hand is declared a push and the player neither wins or loses the wager. If both the player's hands outrank the corresponding dealer's hands, the player wins their wager and is paid even money on their wager.

After settling with each player, the dealer collects the cards of the hands. The players make new wagers and another hand is dealt.

In paying the players for winning hands, players are paid even money on their wager (less a commission if one is assessed).

Further, where the player and dealer tie on a hand, e.g. low hand or high hand, the dealer will be deemed to have the higher ranking Set forth below are some examples of play:

| Player Hands | Dealer Hands |
|---|---|
| Low Hand A | Q |
| High Hand A, A | K, 4 |

In this hand the player is the winner has the highest holding available since the card of the Ace of low hand is the highest ranking card (outranks dealer's Queen) and the pair of Aces is the highest ranking high hand and outranks the dealer's King and 4.

| Player Hands | Dealer Hands |
|---|---|
| Low Hand 5 | 3 |
| High Hand K, 4 | 8,8 |

The hand is a push since the player wins the low hand and the dealer wins the high hand.

| Player Hands | Dealer Hands |
|---|---|
| Low Hand J | J |
| High Hand Q, 6 | K, 9 |

The dealer wins since the low hand is a tie (protocol is that dealer is the winner) and the dealer's high hand outranks the player's

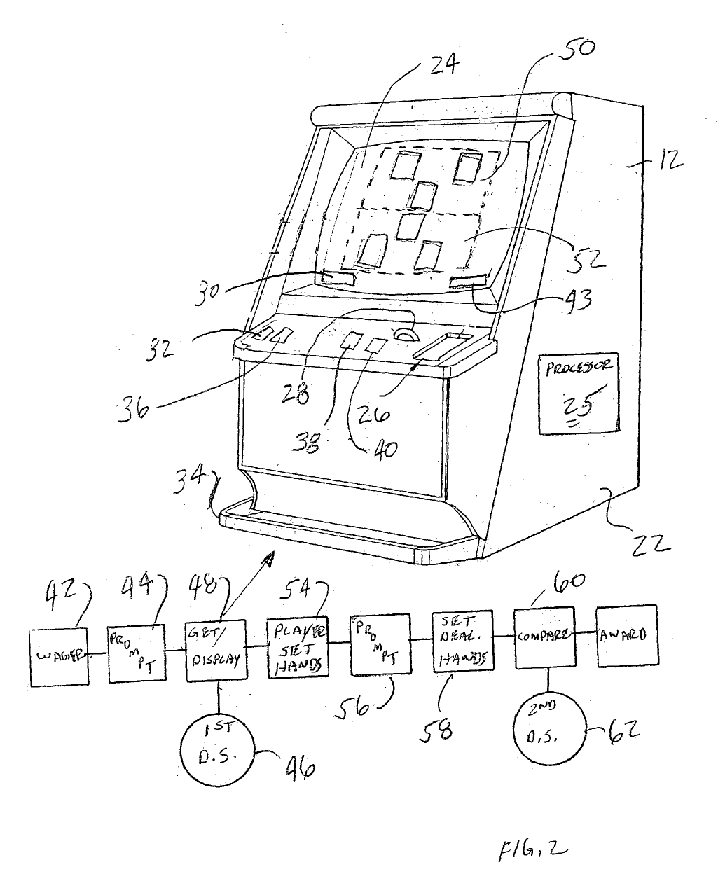

The game as described above can be embodies into an electronic device as shown in FIG. 2. The device 12 has a housing 22 supporting a video display 24 and containing a game processor 25 configured to control play and the display 24 for the device 20 as hereinafter described.

The device 20 has apparatus for a player to make a wager. For example there may be a cash validator 26 and coin slot 28 to receive cash or tokens, respectively, for wagering. The deposited cash or tokens are converted by the processor 24 into gaming credits, the amount of which may be displayed at a credit meter 30 at the display 20.

The device 12 also includes a plurality of buttons for the player to control play of the game. At 32 is a cash out button which, if depressed by the player, prompts the processor 25 to dispense to the player the amount of the credit meter 30. The amount may be dispensed into a tray 34 as tokens or coins or may be dispensed as a ticket or voucher as is known in the art. At 36 is a bet one credit button whereby the player can wager less than a maximum amount for a hand of play. A maximum wager button 38 provides for the player to wager the maximum permitted by the device, e.g. ten credits. There is also a prompt button 40 for the player to prompt play and completion of the game as hereinafter described.

To play the device 12, at 42 the player enters the desired wager using the control buttons and at 44 prompts play. A bet meter 43 may be provided at the display 24 for the player to confirm the amount of the bet. When prompted the processor 25, accesses a first data structure 46 to at 48 randomly select and display at the display 24 a dealer's three card hand 50 (face down) and a face up player three card hand 52. The player, using for example a touch screen display 24, mouse or other input device, sets their low hand and high hand at 54 by arranging the cards in the manner described above. The processor 25 may preclude mis-setting of the player's hand 52 and may initially display the player's hand 52 in a suggested set for the player. After the player is satisfied with the setting of his hand 52, the processor 25 is prompted at 56 to complete play as by the player depressing the prompt button 40. The processor 25 sets and reveals the dealer's hand 50 at 58 according to a pre-programmed manner and at 60 compares the corresponding dealer low and high hands to that of the player according to the predetermined ranking schedule which may be programmed or stored in a second data structure 62. If the player has won the hand, as described above by having higher ranking low and high hands, at 64 the processor 25 issues an award to the player, e.g. an even money payback.

While I shown and described the game, it shoudl be understood that it could be player as an Ace-low game, deuces wild, using a Joker to represent an Ace or as a low game where the player wins when his low and high hands are of a lower ranking

While I have shown and described certain embodiments of the present invention, it is to be understood that it is subject to many modifications without departing from the spirt and scope of the appended claims.

I claim:

1. A method for playing a Poker game using a 52 card deck of playing cards, the method comprising:
the player making a wager;
establishing a hand ranking schedule for play, said Poker ranking being the traditional Poker ranking excluding straights, flushes, four-of-a-kinds and three-of-a-kinds;
dealing three cards to a player and three cards to a dealer face down;
each of the player and dealer cards making a one card low hand and a two card high hand, said high hand having a higher schedule ranking than the low hand;
comparing the rankings of the corresponding player and dealer low and high hands and (a) if both of the player's hands outrank the dealer's hands awarding the player based upon the wager, (b) if both of the dealer's hands outrank the player's hands, collecting the player's wager and (c) if the one of the dealer's hands outranks the corresponding player hand and the other of the dealer's hands is outranked by the corresponding player hand, the player neither wins or loses the wager.

2. A device for playing a poker game comprising:
a computer processor;
an electronic display controlled by the processor;
at least one data structure storing data corresponding to each card of at least a fifty-two card deck of playing cards and a ranking schedule, said schedule being the traditional Poker ranking hierarchy of poker hands excluding straights, flushes, four-of-a-kind and three-of-a-kind;
apparatus for a player to make a wager and prompt play;
said processor configured to, upon prompting of play, randomly select and display at the display three player cards face up and three dealer cards face down;
input apparatus configured for the player to arrange the player cards into a one card low hand and a two card high hand, said high hand having a higher schedule ranking than the low hand;
said processor configured to (a) arrange and display face up the dealer cards into a one card low hand and a two card high hand, said high hand having a higher ranking than the low hand, (b) compare the corresponding player and dealer low and high hands and (c) if both of the player's hands outrank the dealer's issue an award to the player based upon the wager, (d) if both of the dealer's hands outrank the player's, collect the player's wager and (e) if the one of the dealer's hands outranks the corresponding player hand and the other of the dealer's hands is outranked by the corresponding player hand, neither collect the wager or issue an award.
